(19) United States
(12) Patent Application Publication
(10) Pub. No.: US 2007/0176754 A1
(43) Pub. Date: Aug. 2, 2007

(54) Method for operating a transponder, and a transponder device

(75) Inventors: Martin Fischer, Pfedelbach (DE); Ulrich Friedrich, Ellhofen (DE); Jens Masuch, Heilbronn (DE); Michael Pangels, Ludwigsburg (DE); Dirk Ziebertz, Eberstadt (DE)

Correspondence Address: MCGRATH, GEISSLER, OLDS & RICHARDSON, PLLC, P.O. BOX 1364, FAIRFAX, VA, 22038-1364, US

(73) Assignee: ATMEL Germany GmbH

(21) Appl. No.: 11/652,564

(22) Filed: Jan. 12, 2007

Related U.S. Application Data
(60) Provisional application No. 60/839,420, filed on Aug. 23, 2006.

(30) Foreign Application Priority Data
Jan. 16, 2006 (DE) DE 102006002515.6

(51) Int. Cl. H04Q 5/22

(52) U.S. Cl. 340/10.34; 340/10.1; 340/572.1; 340/10.5

(57) ABSTRACT

A method for operating a transponder, and a transponder device is disclosed. Data are wirelessly and bidirectionally transmitted between the transponder and a base station through a first interface that is based on an electromagnetic far-field coupling. According to the invention, data are additionally transmitted wirelessly and bidirectionally between the transponder and the base station through at least one second interface that is based on inductive coupling.

This nonprovisional application claims priority to provisional application No. 60/839,420, which was filed on Aug. 23, 2006, and claims priority to German Patent Application No. DE 102006002515, which was filed in Germany on Jan. 16, 2006, and which are both herein incorporated by reference.

### BACKGROUND OF THE INVENTION

1. Field of the Invention

The present invention relates to a transponder and to a method for operating a transponder.

2. Description of the Background Art

Contactless identification systems, or radio frequency identification (RFID) systems typically include a base station or reader (or reader unit) and a plurality of transponders or remote sensors. The transponders and their transmitting and receiving devices customarily do not have an active transmitter for data transmission to the base station. Such non-active systems are called passive systems if they do not have their own energy supply, and semi-passive systems if they have their own energy supply. Passive transponders take the energy they require for their supply from the electromagnetic field emitted by the base station.

For data transmission between the transponder and the base station, the transponder has an interface of a certain interface type, which is compatible with the corresponding interface type of the base station. In a first, rough categorization, the interface types can be divided into contacting and contactless types.

The interface types in which the data transmission takes place in a contactless way are distinguished, among other characteristics, by the operating or carrier frequency used for data transmission, which is to say the frequency transmitted by the base station. Commonly used frequencies include 125 kHz (LF range), 13.56 MHz (RF range), a frequency range between 860 MHz and 960 MHz (UHF range), and a frequency range above 3 GHz (microwave range).

Another distinguishing feature of different interface types is the type of coupling between the respective interfaces of the transponder and base station. In this regard, a distinction is made between what is called inductive or magnetic coupling and what is called far-field coupling, among other characteristic. In simplified terms, with inductive or near-field coupling an antenna coil of the base station and an antenna coil of the transponder form a transformer, for which reason this coupling type is also called transformer coupling. In the case of inductive coupling, a maximum separation between the transponder and the base station is limited to the region of a near field of the antennas used. The near field region is primarily determined by the operating frequency of the interface.

Far-field coupling relies on the propagation of electromagnetic waves which are emitted by the antenna used. UHF and microwave systems typically rely on far-field coupling. RF and HF systems, in contrast, typically rely on inductive coupling. Fundamentals in this regard can be found in, for example, the “RFID Handbuch,” a textbook by Klaus Finkenzeller, HANSER Verlag, third edition, 2002, section 2.3, “Frequenz, Reichweite Kopplung” (Frequency, Range and Coupling), section 3.2.1, “Induktive Kopplung” (Inductive Coupling), and section 4.2.1.1, “Übergang vom Nah-zum Fernfeld bei Leiterschleifen” (Transition from Near Field to Far Field in Conductive Loops).

In general, load modulation is used to transmit data from a transponder to the base station with inductive coupling; for information on this, refer to Finkenzeller, section 3.2.1.2.1, “Lastmodulation” (Load Modulation), for example.

In general, backscatter coupling is used to transmit data from a transponder to the base station using UHF or microwaves in the far field of the base station. To this end, the base station emits electromagnetic carrier waves, which the transmitting and receiving device in the transponder modulates and reflects appropriately for the data to be transmitted to the base station using a modulation method. The typical modulation methods for this purpose are amplitude modulation, phase modulation and amplitude shift keying (ASK) subcarrier modulation, in which the frequency or the phase position of a subcarrier is changed; in this regard, refer once again to Finkenzeller, section 3.2.2, “elektromagnetische Backscatter-Kopplung” (Electromagnetic Backscatter Coupling).

However, data transmission in the UHF range with electromagnetic far-field coupling is not possible in every country, since the regulations in some countries do not make any free frequencies available in the requisite frequency bands, for example. As a consequence, such transponders cannot be used worldwide.

Moreover, on account of radiated interference or due to the presence of absorbent materials, such as water, data transmission in certain frequency ranges, in particular the UHF and microwave ranges, can be interfered with such that operation of the transponder becomes impossible.

In WO 2005/109328 A1, which corresponds to U.S. Publication No. 20050237163, a transponder remote keyless applications is described, which has an active, unidirectional interface for the UHF frequency range and multiple bidirectional interfaces for the LF frequency range. However, specific functions are assigned to the UHF interface and the relevant LF interfaces, so selective operation of the various interfaces is not possible.

### SUMMARY OF THE INVENTION

It is therefore an object of the present invention to provide a method for operating a transponder, and a transponder device, which permit reliable worldwide operation of the transponder.

In an embodiment, data are wirelessly and bidirectionally transmitted between the transponder and a base station through a first interface that is based on an electromagnetic far-field coupling. In addition, data can be wirelessly and bidirectionally transmitted between the transponder and the base station through a second interface that is based on inductive coupling. Data transmission can take place in alternation, i.e. as a function of the interface that is usable or available at the moment, or can take place simultaneously through both interfaces. This permits reliable operation of the transponder even when, for example, the far-field based coupling is subject to interference or is not possible in a specific country.

In a further embodiment, security-related data are transmitted exclusively through the second interface. In the case of data transmission based on electromagnetic far-field coupling in the UHF or microwave frequency regions, long transmission ranges are achieved, making unauthorized interception of the data transmitted between the transponder and base station relatively easy as compared to near-field coupled systems. This is especially easy in the case of data transmitted from the base station, since these data are transmitted with a relatively high transmit power. Since interception of data transmissions based on inductive coupling is only possible within a short distance from the base station, security against interception is significantly improved thereby.

In a further embodiment, an authentication operation is carried out exclusively through the second interface. An authentication operation is used, for example, to enable write and/or read access to the transponder or its memory. Customarily, a password is transmitted from the base station to the transponder for this purpose, wherein the password can be XOR combined with a random number previously transmitted by the transponder, for example. The authentication operation is also referred to as an access operation. One example of an authentication or access operation is described in the proposed standard ISO/IEC_CD 18000-6C dated Jan. 7, 2005, section 6.3.2.10.3.6. In accordance with the invention, passwords and/or random numbers used for the XOR combination are transmitted exclusively through the second interface when they are transmitted in plain text.

In yet a further embodiment, a Data Encryption Standard (DES) encryption method, a Triple DES encryption method, or an Advanced Encryption Standard (AES) encryption method is performed during data transmission through the second interface. Such computationally intensive encryption methods may require a comparatively large amount of operating power for their execution. In the case of passive transponders with UHF or microwave far-field coupling, the power provided by the electromagnetic field of the base station under typical operating conditions is not adequate for providing the power required for the encryption algorithms.

Further, the base station can execute an anticollision routine through the first interface. When the transponder is selected, the first interface is deactivated and data transmission is subsequently performed exclusively through the second interface. The anticollision routine can be, for example, a deterministic selection method such as a binary tree search method, or a stochastic method such as an ALOHA selection method.

In a further embodiment, the transponder is supplied with operating power exclusively through the first interface and/or through the second interface, i.e., the transponder is passive.

In a further embodiment, data are transmitted from the transponder to the base station through the first interface on the basis of backscatter.

In a further embodiment, the first interface is operated in a frequency range from 400 MHz to 6 GHz. Preferably, the frequency is in the UHF range at 860 MHz to 960 MHz.

In a further embodiment, the second interface is operated in a frequency range from 100 kHz to 150 kHz, or 10 MHz to 20 MHz.

In a further embodiment, both the first and second interfaces are activated after an initialization of the transponder, and when a command is received only the interface through which the command is received remains activated. Alternatively, a field strength measurement is performed at the first and second interfaces, and the interface at which the greater field strength is present is activated. The other interface is then deactivated. In another alternative, a bit error rate is measured at the first and second interfaces, and the interface at which the lower bit error rate is measured is activated. The other interface is then deactivated. The variants described permit simple, automated interface selection based on reproducible criteria, wherein the interface that ensures optimal data transmission is always selected.

The transponder includes, for example, a first interface for bidirectional, wireless data transmission between the transponder and a base station, wherein the first interface is based on electromagnetic far-field coupling. In addition, it can include a second interface for bidirectional, wireless data transmission between the transponder and the base station, wherein the second interface is based on inductive coupling.

In a further embodiment, the transponder includes an interface selection unit that is designed such that it selects the second interface for data transmission in the event of security-related data to be transmitted.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 illustrates an RFID system with a base station and a transponder; and

FIG. 2 illustrates a timing diagram of a selection process.

### DETAILED DESCRIPTION

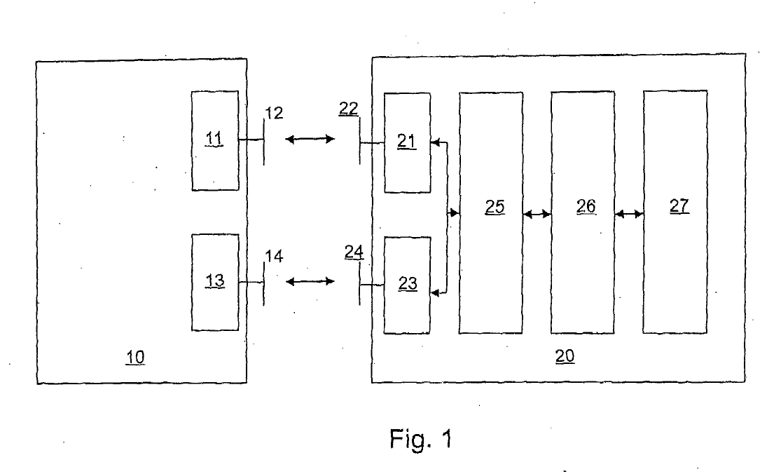

FIG. 1 shows an RFID system 1 with a base station 10 and a transponder 20.

The base station 10 includes a first interface in the form of an analog front end 11, and an antenna 12 coupled to the analog front end 11. The first interface operates through, for example, a far-field coupling in a frequency range from 860 MHz to 960 MHz. The base station 10 additionally includes a second interface in the form of another analog front end 13 and an antenna 14 coupled to the analog front end 13. The second interface operates through an inductive coupling in a frequency range of 13.56 MHz.

The transponder 20 includes a first interface in the form of an analog front end 21 and an antenna 22 coupled to the analog front end 21. The first interface operates, for example, through a far-field coupling in a frequency range from 860 MHz to 960 MHz. Data transmission between the base station 10 and the transponder 20 takes place through their respective first interfaces using, for example, a data transmission protocol in conformity with the proposed standard ISO/IEC_CD 18000-6C dated Jan. 7, 2005. The transponder 20 additionally includes a second interface in the form of another analog front end 23 and an antenna 24 coupled to the analog front end 23. The second interface operates through an inductive coupling in a frequency range of 13.56 MHz. Data transmission between the base station 10 and the transponder 20 takes place through their respective second interfaces in accordance with the ISO 14443 standard.

Data transmission from the transponder 20 to the base station 10 through the first interface 21 and 22 takes place on the basis of backscatter. Data transmission from the transponder 20 to the base station 10 through the second interface 23 and 24 takes place on the basis of load modulation.

The analog front ends 11, 13, 21 and 23 each include circuit components (not shown), which serve to drive the applicable antennas 12, 14, 22 and 24 and to process signals received by the applicable antennas 12, 14, 22 and 24.

The transponder 20 further includes an interface selection unit 25 coupled to the first interface 21 and 22, and to the second interface 23 and 24. The selection unit 25 is designed such that it selects the second interface 23 and 24 for data transmission in the event of security-related data to be transmitted. In addition, the interface selection unit 25 serves to process the signals received from, and those to be transmitted to, the first interface or the first analog front end 21 and the signals received from, and those to be transmitted to, the second interface or second analog front end 23. To this end, the interface selection unit 25 includes digital circuits that are not shown, for instance logic gates, counters, timers, etc.

The interface selection unit 25 is coupled to a data processing unit 26, which can be implemented as a state machine or as a microprocessor, for example. The data processing unit 26 serves to control the function of the transponder 20, and thus implements the application layer in the ISO layer model. For example, the commands transmitted by the base station 10 are processed in the data processing unit 26.

The data processing unit 26 is coupled to an electrically erasable memory 27 that serves to dynamically store transponder application-related data.

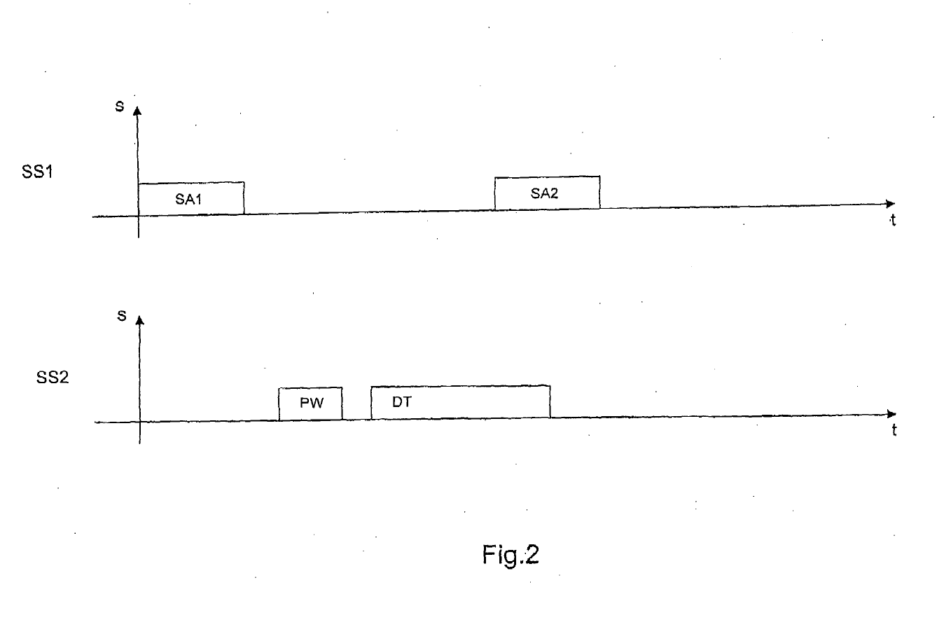

FIG. 2 schematically shows a timing diagram of a selection method and a subsequent authentication, where signals SS1 at the first interface 21 and 22 of the transponder 20 and signals SS2 at the second interface 23 and 24 of the transponder 20 are shown.

The selection method is a conventional slotted ALOHA method. This method is described in detail in the proposed standard ISO/IEC_CD 18000-6C dated Jan. 7, 2005, section 6.3.2 ff., and in particular in FIG. 19 there, for example. To select, the base station 10 first transmits what is called a query command to the first interface 21 and 22 of the transponder 20 in the UHF range during a time interval or first slot SA1. The transponder 20 then switches a state of its internal state machine to an “arbitrate” state. Within the context of the selection method as described in FIG. 19 of the proposed standard, data are now transmitted bidirectionally between the transponder 20 and the base station 10 in the first slot SA1 through the first interface 21 and 22 until the transponder 20 assumes an “open” state.

In order to carry out certain security-related operations with the transponder 20, the base station 10 should transmit a password PW to the transponder 20 within the scope of an authentication operation. If the password PW is correctly transmitted, the transponder 20 switches to a “secure” state. However, the password PW is not transmitted through the first UHF interface 21 and 22, but rather through the near-field coupled HF interface 23 and 24, which is significantly more secure from interception. The transponder 20 now deactivates its first interface 21 and 22, and subsequently communicates with the base station 10 in a time interval DT solely through the second interface 23 and 24.

The base station 10 can now continue the selection process or the selection of additional transponders (not shown) through their first interface 11 and 12 during a time interval SA2 in subsequent slots, while communicating in an overlapping manner with the transponder 20 through its second interface 13 and 14, i.e. reading out a memory area, for example.

It is possible for powerful encryption algorithms, such as a DES encryption method, a triple DES encryption method, or an AES encryption method, to be performed during the data transmission through the second interface 23 and 24. This produces an additional drastic reduction in the danger of interception.

The transponder 20 is passive, i.e. it is supplied with operating power exclusively through the first interface 21 and 22 and/or through the second interface 23 and 24.

When the requirements for security from interception are low, the interfaces of the transponder 20 can also be operated with equal privileges, in other words, all functions are accessible through both interfaces, i.e., an authentication is also possible through the first interface 21 and 22, for example.

The interface selection can take place in accordance with a variety of criteria here. For example, it is possible for both the first and second interfaces to be activated following initialization of the transponder. However, when a command is received, only the interface through which the command is received remains activated.

Alternatively, a field strength measurement can be performed at the first and second interfaces, for example. Then, the interface at which the greater field strength is present is activated, while the other interface is deactivated. The inclusion of a bit error rate as a selection criterion is also possible.

The use of interfaces with equal privileges permits worldwide operation of the transponder 20, even in countries where no UHF data transmission is possible, especially in Asia.

Of course, additional interfaces of another type can also be provided in the transponder 20 along with the two interfaces 21 and 22, and 23 and 24, shown. Moreover, it is possible for a separate base unit having only one type-specific interface to be provided for each interface type, i.e., it is possible for the transponder 20 to be operated with base stations having only one of the two interface types.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for operating a transponder, the method comprising:
transmitting data wirelessly and bidirectionally between the transponder and a base station through a first interface that is based on an electromagnetic far-field coupling; and
transmitting data wirelessly and bidirectionally between the transponder and the base station through at least one second interface that is based on inductive coupling.

2. The method according to claim 1, wherein security-related data are transmitted exclusively through the second interface.

3. The method according to claim 1, wherein passwords are transmitted exclusively through the second interface.

4. The method according to claim 1, wherein an authentication operation is carried out exclusively through the second interface.

5. The method according to claim 1, wherein a DES encryption method, a triple DES encryption method, or an AES encryption method is performed during data transmission through the second interface.

6. The method according to claim 1, wherein the base station executes an anticollision routine through the first interface, and wherein, when the transponder is selected, the first interface is deactivated and data transmission is performed exclusively through the second interface.

7. The method according to claim 1, wherein the transponder is supplied with operating power through the first interface and/or through the second interface.

8. The method according to claim 1, wherein data are transmitted from the transponder to the base station through the first interface on the basis of backscatter.

9. The method according to claim 1, wherein the first interface is operated in a frequency range from 400 MHz to 6 GHz.

10. The method according to claim 1, wherein the second interface is operated in a frequency range from 100 kHz to 150 kHz, or 10 MHz to 20 MHz.

11. The method according to claim 1, wherein both the first and second interfaces are activated after an initialization of the transponder, and when a command is received, only the interface through which the command is received remains activated.

12. The method according to claim 1, wherein a field strength measurement is performed at the first and second interfaces, and the interface at which the greater field strength is present is activated, while the other interface is deactivated.

13. The method according to claim 1, wherein a bit error rate is measured at the first and second interfaces, and the interface at which the lower bit error rate is measured is activated, while the other interface is deactivated.

14. A transponder comprising:
a first interface for bidirectional, wireless data transmission between the transponder and a base station, wherein the first interface is based on electromagnetic far-field coupling; and
a second interface for bidirectional, wireless data transmission between the transponder and the base station, wherein the second interface is based on inductive coupling.

15. The transponder according to claim 14, further comprising an interface selection unit for selecting the second interface for data transmission in the event of security-related data to be transmitted.
